(19) United States
(12) Patent Application Publication
(10) Pub. No.: US 2005/0249336 A1
(43) Pub. Date: Nov. 10, 2005

(54) Telephone adaptor module with rule-based audio playback and wireless function programming capability

(76) Inventors: Otman Adam Basir, Waterloo (CA); Jean-Pierre Bhavnani, Kitchener (CA); Jean Paul Dupuis, Kitchener (CA); David Bullock, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 11/125,414

(22) Filed: May 9, 2005

Related U.S. Application Data
(60) Provisional application No. 60/569,075, filed on May 7, 2004.

(51) Int. Cl. H04M 1/64

(52) U.S. Cl. 379/79; 379/67.1

(57) ABSTRACT

A telephone system includes a telephone adaptor module with rule-based audio playback in wireless function programming capabilities. The system allows existing telephones to be retrofit with rule-based audio playback functionality. A physically independent remote programming device is used for transmitting function programming information in audio content to the device via wired or wireless transmission. Rule-based audio playback provides ring tone functionality in which user selected audio clips may be played back instead of the conventional telephone ring. The audio clip that is played when a call is received will be based on the rule-based playback scheme programmed by the user. Audio content may also be played back according to programmed rules which do not require a telephone call to be received, but can be activated by other conditions (time of day, temperature, etc.).

This application claims priority to U.S. Provisional Application Ser. No. 60/569,075, filed May 7, 2004.

### BACKGROUND OF THE INVENTION

The present invention relates generally to telephone accessories, and more particularly to a device capable of adding rule-based audio content playback functionality to a standard phone line via wireless and wired function programming.

Conventional home telephones produce a well-known ringing sound to indicate the arrival of a telephone call. Variants of the conventional home telephone allowed user to vary the pitch or duration of the ringing sound. Mobile phones have expanded this functionality with the introduction of ring tones. Ring tones exist in several variations: monophonic, polyphonic and master tones that are “true audio” clips comparable to CD quality. These ring tones are purchased from a content distributor who licenses the content from the original source.

Recently, landline home telephones have been introduced which come with ring tone functionality as a factory installed option. However, there are several drawbacks to the currently offered telephones, including the fact that the user must replace their existing telephone in order to obtain the ring tone functionality.

### SUMMARY OF THE INVENTION

The present invention provides a telephone adaptor module purchased separately from the telephone set that provides the enhanced ring tone functionality on a home phone line. This accessory module allows conventional telephone systems to be retrofitted with enhanced ring tone functionality with audio clip selection being a function of time of day, caller ID and a number of other programmable factors.

Generally, the telephone adaptor module includes a telephone line input jack and a processor connected to the input jack. The processor detects an incoming call and retrieves and plays an audio file in response to the incoming call. The telephone adaptor module may include a telephone line output jack, which passes through a telephone signal input jack so that the user's existing telephone set can be connected to the telephone line output jack.

The telephone adaptor module further includes a data port, such as a wired or wireless data port, for receiving a plurality of audio files to be played by the processor. The audio files are selected by an external programming device, such as a user's home computer or PDA, which can be connected to the telephone adaptor module wirelessly or via the wired port. A programming device is used to choose audio files from an internet website, download the audio files, assign audio files to playback criteria (e.g. caller ID, time of day, time of year, etc.) and to change any other programmable options on the telephone adaptor module.

### BRIEF DESCRIPTION OF THE DRAWINGS

Other advantages of the present invention can be understood by reference to the following detailed description when considered in connection with the accompanying drawings wherein:

FIG. 1 illustrates the telephone system of the present invention.

FIG. 2 is a block level diagram of the system of FIG. 1.

FIG. 3 is an example set of playback rules which could be used in the telephone adaptor module of FIGS. 1 and 2.

### DETAILED DESCRIPTION OF THE PREFERRED EMBODIMENTS

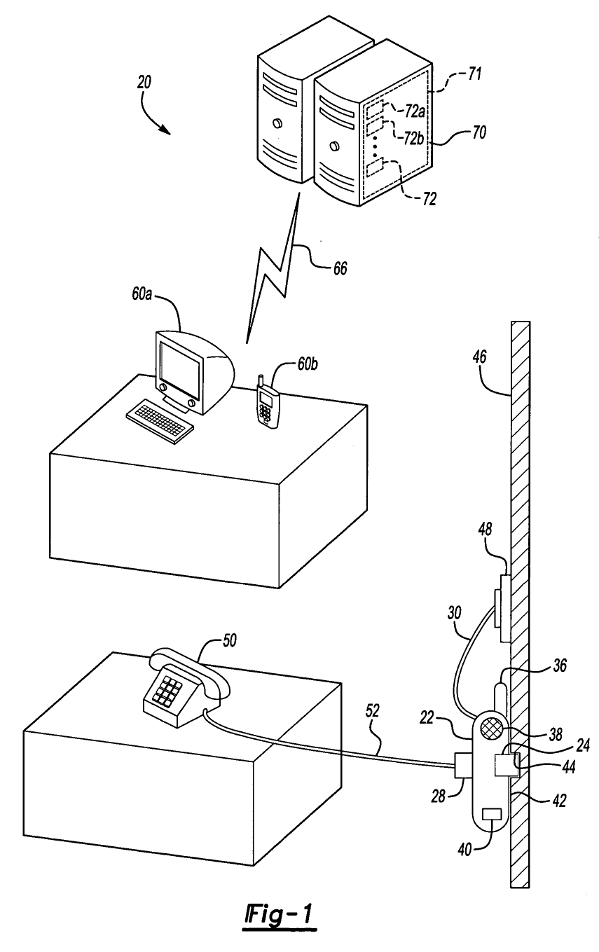

A telephone system 20 according to the present invention is shown in FIG. 1. The telephone system 20 consists of an adaptor module 22 having a telephone line input jack 24 and a telephone line output jack 28. The telephone adaptor module 22 further includes a power cord 30 (or could optionally be battery powered), a wireless communication antenna 36 and a wired data port 40. The telephone adaptor module 22 further includes an audio speaker 38. A telephone adaptor module 22 further includes a housing 42.

The telephone adaptor module 22 is connected to a home landline telephone jack 44 via the telephone input jack 24, which secures the telephone adaptor module 22 and its housing 42 against an interior wall 46. The power cord 30 is connected to an electrical outlet 48 to supply power to the telephone adaptor module 22.

The telephone adaptor module 22 is connected to a home landline telephone 50 via a telephone line 52 connected to the telephone output jack 28 of the telephone adaptor module 22. The telephone 50 could be a corded or cordless telephone 50.

Via the wireless communication antenna 36 and/or the wired port 40, the telephone adaptor module 22 communicates with a remote programming device 60A or 60B (referred generically as programming device 60), where programming device 60A is a home computer and programming device 60B is a hand held computing device, such as a PDA. The programming device 60 is connected via the internet 66 to servers 70. Servers 70 host a website 71 from which audio files 72 can be selected, purchased and downloaded to the programming device 60. Audio files 72 are true audio clips, and may be compressed audio clips, such as WAV files, mp3 files, AAC, etc. Although the operation will be described in more detail below, generally the programming device 60 provides a user interface for a user to browse the website 71 via the internet 66 and download audio files 72 to the programming device 60. The programming device 60 then communicates with the telephone adaptor module 22 via the wireless communication antenna 36 or wired data port 40. In this manner, the selected audio files are loaded onto the telephone adaptor module 22. The programming device 60 is also used to define playback criteria, i.e., when particular audio files 72 are to be played over the speaker 38.

The processor 70 also stores, in non-volatile onboard memory, data uniquely identifying the programming device 60 which allows only authorized programming modules to alter the audio content and function programming. This can be done using known wireless communication security protocols, such as known Bluetooth security protocols.

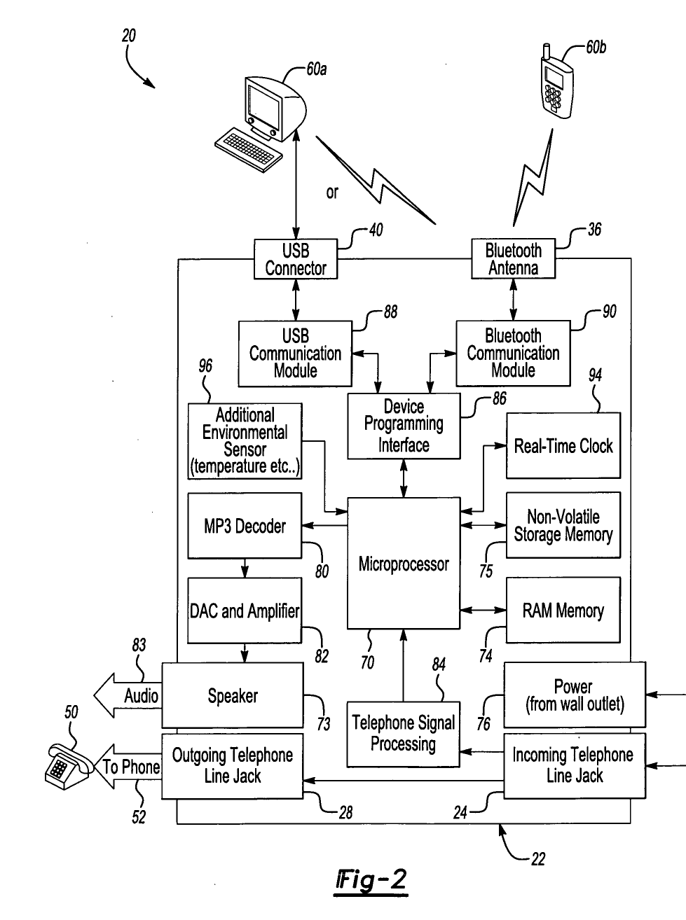

FIG. 2 is a block level diagram of the system 20 of FIG. 1. The telephone adaptor module 22 includes a microprocessor 70 in communication with storage, such as memory 72 and/or RAM memory 74. The storage may also include hard drives, flash memory, optical storage or any other digital storage. Power is received via power supply 76. The storage stores the downloaded audio clips 72 and any playback criteria and programming to perform the functions described herein. The microprocessor 70 may be programmed to decode the stored audio files 72 or may pass them along to a separate hardware decoder 80. The decoder 80 is output to a digital the analog converter and amplifier 82, which drives the speaker 38 and optionally an audio output jack 83 for connection to an external speaker or audio device.

The telephone adaptor module 22 includes a telephone signal processing module 84 which includes caller ID processing which is sent to the microprocessor 70. The microprocessor 70 is connected via a device programming interface 86 to a wired communication module 88 (such as USB) and wireless communication module 90 (such as Bluetooth). The wired communication module 88 is connected to the wired port 40 while the wireless communication module 90 is connected to the wireless communication antenna 36. The incoming telephone line jack 24 is sent to both the telephone signal processing module 84 and passed along in parallel to the telephone output jack 28, which may then be connected to the telephone 50 via a phone line 52.

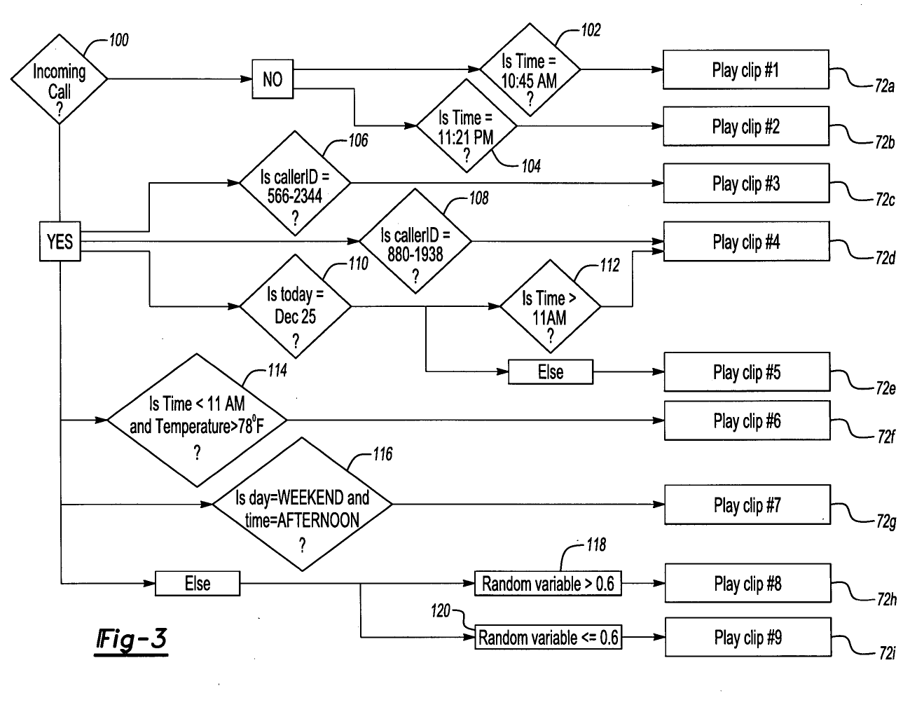

The telephone adaptor module 22 may further include additional inputs and/or sensors, such as a real time clock 94, indicating time of day, date, time of year, season, etc. Environmental sensors 96 may indicate temperature, humidity, etc. The clock 94, environmental sensors 96 and telephone signal processing module 84 provide inputs for use in playback criteria, some examples of which are shown in FIG. 3.

Generally, the telephone adaptor module 22 stores a plurality of audio files 72 each of which is associated with one or more playback criteria via the user interface on the programming device 60. The playback criteria can include information from the clock 94, environmental sensors 96 and telephone signal processing module 84.

A plurality of playback criteria are illustrated in FIG. 3 for purposes of illustration. Other criteria could also be utilized. In step 100, the microprocessor 70 (via the telephone signal processing module 84) determines whether a telephone call is incoming on input jack 24. If not, additional rules may be processed. For example, rules 102 and 104 may be activated based upon time of day and based upon the fact that there is no current incoming call, thereby playing audio clips 72A and 72B, respectively.

If an incoming call is detected in step 100, then the caller ID information provided by telephone signal processing module 84 can be checked by microprocessor 70 for matches in rules 106 and 108, in which case audio files 72C and 72D would be played, respectively. Alternatively, if the date rule is met in rule 110, and if the time rule 112 is also met, the audio files 72D may be played. Otherwise, if the date rule 110 is met, but not the time rule 112, audio files 72E will be played.

For another example, if an incoming call is detected, and rule 114 is met regarding time and temperature, audio file 72F is played. If rule 116 is met regarding whether the current day is a weekend and the current time is afternoon, audio file 72G is played. Otherwise, in rules 118 and 120, based upon random variables generated in microprocessor 70, audio clips 72H and 72I, respectively.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A telephone adaptor module comprising:
a telephone line input jack; and
a processor connected to the input jack, the processor detecting an incoming call and retrieving and playing an audio file in response to the incoming call.

2. The telephone adaptor module of claim 1 further including a telephone line output jack passing through a telephone signal from the input jack.

3. The telephone adaptor module of claim 2 further including a speaker, the processor playing the audio file over the speaker.

4. The telephone adaptor module of claim 3 wherein the audio file is one of a plurality of audio files, the telephone adaptor module further including a data port for receiving the plurality of audio files and storage for storing the plurality of audio files, the processor retrieving at least one audio file from the storage in response to the incoming call.

5. The telephone adaptor module of claim 4 connected to a telephone via the output jack.

6. The telephone adaptor module of claim 4 wherein the processor selects from among the plurality of audio files based upon information in the telephone signal.

7. The telephone adaptor module of claim 4 further including a wireless communication circuit connected to the data port for receiving the plurality of audio files.

8. The telephone adaptor module of claim 4 wherein the processor receives programming instructions via the data port.

9. The telephone adaptor module of claim 8 further including a wireless communication circuit connected to the data port for receiving the programming instructions.

10. The telephone adaptor module of claim 8 wherein the programming instructions include associations of each of the plurality of audio files with playback criteria.

11. The telephone adaptor module of claim 8 wherein the audio file is a compressed audio file.

12. The telephone adaptor module of claim 10 wherein the playback criteria includes caller-id information.

13. The telephone adaptor module of claim 10 wherein the playback criteria includes a current time of day.

14. The telephone adaptor module of claim 10 wherein the playback criteria includes a current time of year.

15. The telephone adaptor module of claim 1 wherein the input jack and the processor are located in a playback module, the system further including a programming device remote from the playback module, the programming device including a user interface for selecting the audio file from among a plurality of audio files.

16. The telephone adaptor module of claim 14 wherein the programming device is programmed to permit a user to download the audio file from a website.

17. A method for playing an audio file including the steps of:
detecting an incoming call over a telephone line;
selecting an audio file based upon the detection of the incoming call; and
playing the audio file over a speaker based upon the detection of the incoming call.

18. The method of claim 17 further including the step of downloading the audio file from a website.

19. The method of claim 18 wherein the incoming call is received over the telephone line and wherein the telephone line is a telephone landline.

20. The method of claim 19 wherein the step of selecting is performed over a wireless communication interface.
